(19) United States
(12) Patent Application Publication
(10) Pub. No.: US 2026/0142341 A1
(43) Pub. Date: May 21, 2026

(54) POWER STORAGE DEVICE

(71) Applicant: TOYOTA JIDOSHA KABUSHIKI KAISHA, Toyota-shi (JP)

(72) Inventors: Kunihiro TSUNEKAWA, Toyota-shi (JP); Koki NAKADA, Toyota-shi (JP); Shinya TAKESHITA, Toyota-shi (JP); Naoyuki TAKAHASHI, Toyoake-shi (JP); Ryo KIMURA, Nagoya-shi (JP); Kazuhito KATO, Toyota-shi (JP); Toshihiro SHIMONAKA, Toyota-shi (JP); Kota ICHISAWA, Toyota-shi (JP); Kenta MIYAHARA, Toyohashi-shi (JP)

(73) Assignee: TOYOTA JIDOSHA KABUSHIKI KAISHA, Toyota-shi (JP)

(21) Appl. No.: 19/351,742

(22) Filed: Oct. 7, 2025

(30) Foreign Application Priority Data
Nov. 15, 2024 (JP) 2024-199598

(51) Int. Cl. H01M 50/519; H01M 50/209; H01M 50/291; H01M 50/367; H01M 50/55

(52) U.S. Cl. CPC H01M 50/519; H01M 50/291; H01M 50/367; H01M 50/55; H01M 50/209

(57) ABSTRACT

A power storage device includes a first power storage cell including an electrode terminal, and a wiring board. The wiring board includes a substrate and a first conductor member provided on the substrate. The electrode terminal of the first power storage cell and the first conductor member are electrically connected to each other. The substrate is further provided with one or more guide members that guide the first power storage cell such that a position of the electrode terminal of the first power storage cell is aligned with a position of the first conductor member.

### CROSS-REFERENCE TO RELATED APPLICATION

This application claims priority to Japanese Patent Application No. 2024-199598 filed on Nov. 15, 2024. The disclosure of the above-identified application, including the specification, drawings, and claims, is incorporated by reference herein in its entirety.

### BACKGROUND

### 1. Technical Field

The present disclosure relates to a power storage device.

### 2. Description of Related Art

Chinese Patent Application Publication No. 116686151 discloses a power storage device including a plurality of power storage cells fixed in a case (housing cavity). Electrode terminals of each power storage cell are provided to face the bottom wall of the case.

### SUMMARY

The power storage device described in Chinese Patent Application Publication No. 116686151 has a problem of difficulty in adjusting the positions of the electrode terminals of the power storage cells when mounting the power storage cells.

The present disclosure has been made to solve the above problem, and has an object to provide a power storage device in which power storage cells can easily be mounted at appropriate positions.

An aspect of the present disclosure provides a power storage device. The power storage device includes a first power storage cell including an electrode terminal, and a wiring board. The wiring board includes a substrate and a first conductor member provided on the substrate. The electrode terminal of the first power storage cell and the first conductor member are electrically connected to each other. The substrate is further provided with one or more guide members that guide the first power storage cell such that a position of the electrode terminal of the first power storage cell is aligned with a position of the first conductor member.

According to the present disclosure, it is possible to provide the power storage device in which the power storage cells can easily be mounted at appropriate positions.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 illustrates an overview of a power storage device according to an embodiment of the present disclosure;

FIG. 2 shows the interior of the power storage device according to the embodiment of the present disclosure;

FIG. 3 is an end view of the power storage device taken along line III-III in FIG. 2;

FIG. 4 illustrates the configuration and function of guide members shown in FIG. 2;

FIG. 5 shows the configuration of a power storage cell and guide members according to a modification; and

FIG. 6 shows a modification of the configuration shown in FIG. 2.

### DETAILED DESCRIPTION OF EMBODIMENTS

An embodiment of the present disclosure will be described in detail with reference to the drawings. The same or corresponding portions are denoted by the same signs throughout the drawings, and description thereof will not be repeated. In the drawings referred to in the following description, the X-axis, the Y-axis, and the Z-axis indicate three axes that are perpendicular to each other. Hereinafter, the directions indicated by the arrows of the X-axis, the Y-axis, and the Z-axis are denoted with a plus sign “+,” and the opposite directions are denoted with a minus sign “−.”

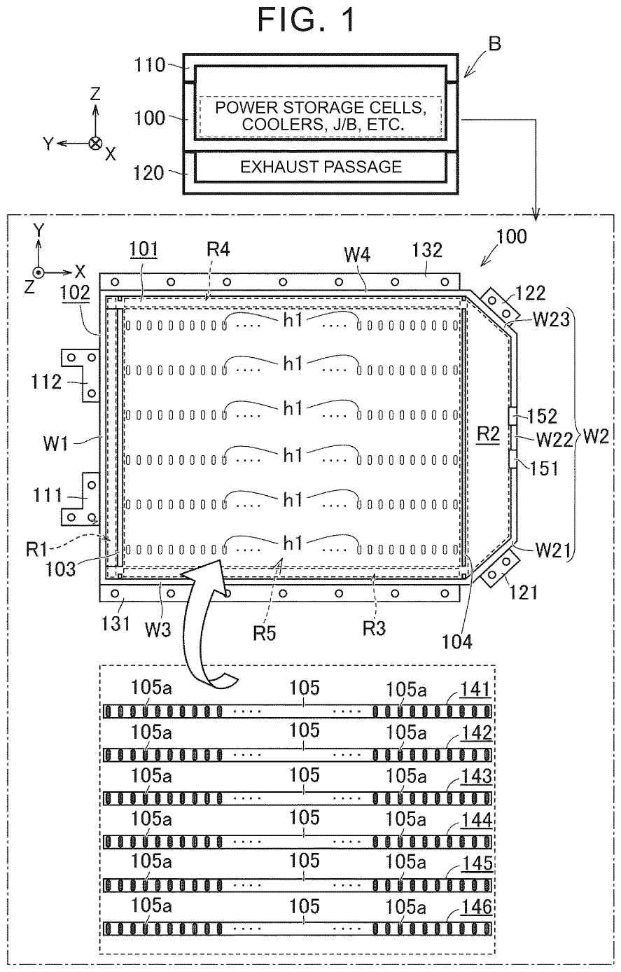

FIG. 1 illustrates an overview of a power storage device according to the present embodiment.

Referring to FIG. 1, a power storage device B according to the present embodiment includes a lower case 100 (first housing member), an upper cover 110 (second

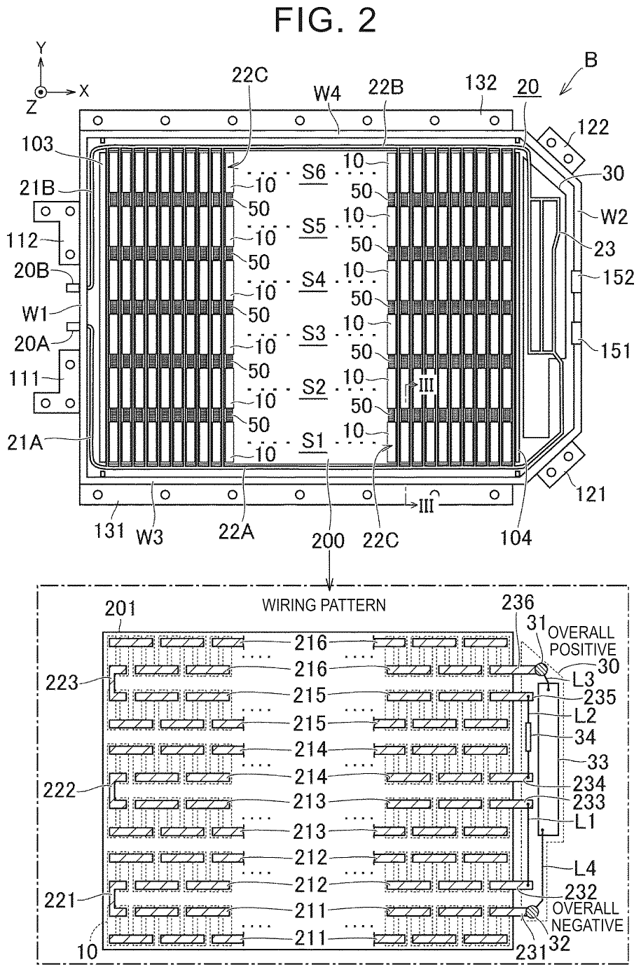

housing member), and a common panel 120 (third housing member), and these components serve as a housing for the power storage device B. The lower case 100 is open upward (on the +Z-side), and houses a plurality of power storage cells and various components associated with these power storage cells. As will be described in detail later, the lower case 100 houses the power storage cells, a cooler, a junction box (hereinafter referred to as “J/B”), etc. (see FIG. 2). The upper cover 110 and the common panel 120 are each fixed to the lower case 100. The upper cover 110 is disposed above the lower case 100 and serves as a lid for the lower case 100. The common panel 120 is disposed below (on the −Z-side of) the lower case 100, and serves to reduce shocks on the lower case 100 caused by road surface interference. An exhaust passage is formed between the lower case 100 and the common panel 120.

For example, in the state where the power storage device B is mounted on a vehicle, the −Z-side is downward (downward in the vertical direction), the +Z-side is upward (upward in the vertical direction), the −X-side is toward the front of the vehicle, and the +X-side is toward the rear of the vehicle. The power storage device B may serve as a traction power storage device that is commonly referred to as “battery pack.” The vehicle may be a battery electric vehicle (BEV) or any other type of electrified vehicle (xEV).

The lower part of FIG. 1 shows the lower case 100 in an empty state (a state in which nothing is housed) as viewed from above (+Z-side). The lower case 100 includes a bottom wall 101 (bottom) and a peripheral wall 102 (peripheral portion). The bottom wall 101 includes regions R1 to R5. The peripheral wall 102 includes side walls W1 to W4. The side walls W1, W2, W3, W4 correspond to the ends of the lower case 100 on the −X-side, the +X-side, the −Y-side, and the +Y-side, respectively. The side wall W2 includes side walls W21 to W23. The side walls W21 to W23 are located on the +X-side of the side walls W3, W4 extending in the X-direction. The side walls W21, W23 are provided with brackets 121, 122, respectively. The side wall W22 is provided with exhaust valves 151, 152. The side wall W22 is connected to the side walls W3, W4 via the side walls W21, W23, respectively. The opposite (−X-side) ends of the side walls W3, W4 are connected to each other via the side wall W1 extending in the Y-direction. The side walls W3, W4 are provided with brackets 131, 132, respectively. The side wall W1 is provided with brackets 111, 112. Each of the side walls W1 to W4 stands from the peripheral edge of the bottom wall 101 toward the +Z-side. The internal space of the lower case 100 is surrounded by the side walls W1 to W4. The power storage device B may be connected to the body (e.g., a floor panel) of the vehicle by fastening the brackets to a floor member of the vehicle.

The bottom wall 101 is provided with partition walls 103, 104 extending in the Y-direction. The partition walls 103, 104 may be fastened to the bottom wall 101. The partition wall 104 is located on the +X-side of the partition wall 103. The partition walls 103, 104 stand from the bottom wall 101 toward the +Z-side. The region R5 is a rectangular region located in the central portion of the lower case 100 and is defined by the partition walls 103, 104. The region R5 is a region where a wiring board 200 and power storage stacks S1 to S6 (see FIG. 2) described later are arranged.

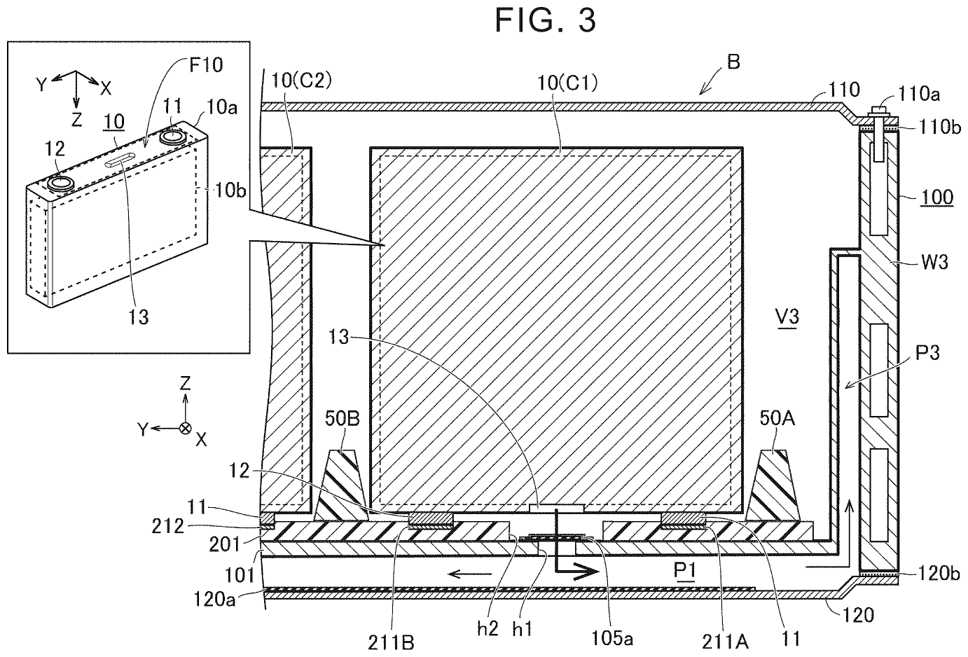

The region R5 has openings h1 at positions where the power storage cells are disposed. Each of the openings h1 is disposed to face a valve 13 (see FIG. 3) of a corresponding one of power storage cells 10 described later in the Z-direction. The openings h1 are arranged in the X-direction to form rows of the openings h1. The number of rows (rows of the openings h1) formed in the bottom wall 101 corresponds to the number of power storage stacks. The openings h1 are holes that extend through the bottom wall 101. The openings h1 are formed by, for example, punching.

In the present embodiment, cover members 141 to 146 are provided in the region R5 of the bottom wall 101. All of the openings h1 formed in the bottom wall 101 are thus covered by the cover members 141 to 146. Each of the cover members 141 to 146 includes a base 105 that is elongated in the X-direction, and N lids 105a arranged in the X-direction. In the present embodiment, the number of power storage cells included in one power storage stack is also N. N is, for example, 20 or more and 50 or less. However, the present disclosure is not limited to this, and N may be 2 or more and less than 20, or may be more than 50.

The base 105 may have an adhesive on its one surface (adhesive surface). The base 105 may be, for example, an adhesive tape such as a polypropylene (PP) tape. The N lids 105a are formed on the base 105. In the present embodiment, the lids 105a contain mica. The N lids 105a of each of the cover members 141, 142, 143, 144, 145, 146 are formed to close the openings h1 located below a corresponding one of the power storage stacks S1, S2, S3, S4, S5, S6 (see FIG. 2) described later. The size of the lid 105a is the same as or greater than the size of the opening h1. For example, the N lids 105a may be formed on the base 105 by attaching N pieces of mica foil to the adhesive surface of the base 105. Alternatively, the N lids 105a may be formed on the base 105 by forming N through holes in the base 105 and providing mica foil in each of the through holes. Each of the cover members 141 to 146 is attached to the upper surface (the +Z-side surface) of the bottom wall 101 via, for example, the adhesive surface of the base 105. As described above, the portions of the lower case 100 that face the valves 13 (FIG. 3) of the power storage cells 10 contain mica. Mica is excellent in heat resistance and electrical insulation properties.

The regions R3, R4 are provided on the −Y-side and the +Y-side of the region R5, respectively. The region R1 is provided outward (on the −X-side) of the partition wall 103. The region R2 is provided outward (on the +X-side) of the partition wall 104. The region R2 is a region where a battery circuit unit 30 (FIG. 2) described later is disposed. The region R2 is defined by the partition wall 104 and the side wall W2. In the present embodiment, the bottom wall 101, the peripheral wall 102, and the partition walls 103, 104 are each made of metal. However, the material of these walls can be changed as appropriate.

FIG. 2 shows the interior of the lower case 100 (the interior of the power storage device B) with the upper cover 110 removed as viewed from above. Referring to FIG. 2, the power storage stacks S1 to S6, a cooling device 20, the battery circuit unit 30, and the wiring board 200 are housed between the lower case 100 and the upper cover 110. Each of the power storage stacks S1 to S6 includes N power storage cells 10 arranged in the X-direction. The configuration of each power storage cell will be described in detail later. The wiring board 200 has a wiring pattern for the power storage stacks S1 to S6. The battery circuit unit 30 includes a circuit electrically connected to the power storage stacks S1 to S6. The battery circuit unit 30 may be a single unit, or may include a plurality of units.

The cooling device 20 includes ports 20A, 20B, pipes 21A, 21B extending in the Y-direction, pipes 22A, 22B extending in the X-direction, a plurality of coolers 22C extending in the Y-direction, and a cooling pipe 23. These components are connected in the following order from the upstream side: port 20A, pipe 21A, pipe 22A, cooling pipe 23, pipe 22B, pipe 21B, and port 20B. The pipes 22A, 22B are connected to each other via the coolers 22C (cooling plates) arranged in the X-direction. In each of the power storage stacks, the cooler 22C is disposed between the power storage cells adjacent to each other in the X-direction. The adjacent power storage cells are cooled by a cooling medium flowing through a channel formed inside the cooler 22C. Each cooler 22C has a channel communicating with each of the pipes 22A, 22B. The cooling pipe 23 is configured to cool the battery circuit unit 30.

Referring to FIGS. 1 and 2, the ports 20A, 20B are provided on the side wall W1. The port 20B is located on the +Y-side of the port 20A. The pipes 21A, 21B are disposed in the region R1. The pipes 22A, 22B are disposed in the regions R3, R4, respectively. The cooling pipe 23 is disposed in the region R2. The coolers 22C are disposed in the region R5. The cooling medium supplied from the port 20A to the pipe 21A flows through the pipe 21A toward the −Y-side. The cooling medium that has entered the pipe 22A from the pipe 21A flows through the pipe 22A toward the +X-side, namely toward the cooling pipe 23, and also flows into the channels in the coolers 22C. The cooling medium that has entered the coolers 22C from the pipe 22A flows toward the +Y-side, namely toward the pipe 22B, while sequentially cooling the power storage stacks S1 to S6. The cooling medium that has entered the cooling pipe 23 from the pipe 22A flows toward the +Y-side, namely toward the pipe 22B, while cooling the battery circuit unit 30. The cooling medium that has entered the pipe 22B from the coolers 22C or the cooling pipe 23 flows through the pipe 22B toward the −X-side, namely toward the pipe 21B. The cooling medium then flows through the pipe 21B toward the −Y-side and flows out from the port 20B. The cooling medium may be a liquid (such as water, oil, or antifreeze solution) or a gas.

In the present embodiment, the wiring board 200 is disposed on the +Z-side of the bottom wall 101, and the power storage stacks S1 to S6 are disposed on the +Z-side of the wiring board 200.

FIG. 3 is an end view of the power storage device B taken along line III-III in FIG. 2. A perspective view of the power storage cell 10 is shown on the left side of FIG. 3.

As shown in the perspective view on the left side of FIG. 3, the power storage cell 10 includes a case 10a and an electrode assembly 10b housed in the case 10a. The case 10a is a rectangular parallelepiped case. The electrode assembly 10b may include one or more windings (e.g., two windings). The winding has a structure in which, for example, a cathode sheet and an anode sheet are wound with a separator interposed therebetween. Each of the cathode sheet and the anode sheet includes an electrode foil and an active material layer. The power storage cell 10 is a secondary cell such as a lithium-ion cell, a nickel metal hydride cell, or a sodium-ion cell. In the present embodiment, a liquid lithium-ion cell is used as the power storage cell 10. The case 10a contains an electrolyte solution together with the electrode assembly 10b. The secondary cell may be of any type, and may be, for example, an all-solid-state secondary cell. A stack (e.g., a stack in which a cathode sheet and an anode sheet are stacked with a separator interposed therebetween) may be used instead of the winding.

The power storage cell 10 has electrode terminals 11, 12 and the valve 13 on the same surface. Specifically, the electrode terminals 11, 12 and the valve 13 are provided on a surface F10 of the case 10a. The surface F10 corresponds to an end face of the power storage cell 10 on one side in the height direction (Z-direction). The valve 13 serves as an exhaust valve. The case 10a is basically maintained in a sealed state. However, when the pressure inside the case 10a exceeds a first reference value, the valve 13 opens to reduce the pressure inside the case 10a. The electrode terminal 11 and the electrode terminal 12 are respectively electrically connected to the cathode sheet and the anode sheet of the electrode assembly 10b, and respectively serve as a cathode terminal and an anode terminal. The portions of the case 10a that surround the electrode terminals 11 and 12 may be made of an insulating material, and the other portions of the case 10a may be made of metal. However, the present disclosure is not limited to this, and the case 10a may be made of any material.

In the present embodiment, the power storage cells included in the power storage stacks S1 to S6 have the same configuration (the configuration shown in FIG. 3). Forming the power storage stacks S1 to S6 using the same type of power storage cells 10 facilitates the manufacturing of the power storage device B and reduces the manufacturing cost. However, the present disclosure is not limited to this, and each power storage stack may include a plurality of types of power storage cells. The number of power storage stacks can be changed as appropriate. The number of power storage stacks may be one or more.

The power storage cells included in the power storage stacks S1 to S6 are electrically connected by the wiring pattern of the wiring board 200. The wiring board 200 is, for example, a panel with a wiring pattern. An example of the wiring pattern of the wiring board 200 is shown in the lower part of FIG. 2.

Specifically, the wiring board 200 includes a rectangular substrate 201, a plurality of conductor members 211, a plurality of conductor members 212, a plurality of conductor members 213, a plurality of conductor members 214, a plurality of conductor members 215, a plurality of conductor members 216, conductor members 221 to 223, and conductor members 231 to 236. The substrate 201 is an insulating substrate that has insulating properties. The substrate 201 may contain a resin (e.g., a thermosetting resin).

Each of the conductor members 211 electrically connects the power storage cells included in the power storage stack S1. Each of the conductor members 212 electrically connects the power storage cells included in the power storage stack S2. Each of the conductor members 213 electrically connects the power storage cells included in the power storage stack S3. Each of the conductor members 214 electrically connects the power storage cells included in the power storage stack S4. Each of the conductor members 215 electrically connects the power storage cells included in the power storage stack S5. Each of the conductor members 216 electrically connects the power storage cells included in the power storage stack S6.

The conductor member 221 electrically connects the power storage stacks S1, S2. The conductor member 222 electrically connects the power storage stacks S3, S4. The conductor member 223 electrically connects the power storage stacks S5, S6. The conductor members 231, 232, 233, 234, 235, 236 electrically connect the power storage stacks S1, S2, S3, S4, S5, S6 to the battery circuit unit 30, respectively.

In the present embodiment, the wiring pattern of the wiring board 200 is formed by the above conductor members. Each of the conductor members 211 to 216, 221 to 223, 231 to 236 is, for example, a plate-shaped member made of metal. Each of the conductor members 221 to 223 may be a U-shaped plate member. Each conductor member may be a busbar. In the present embodiment, each of the conductor members is fixed in a corresponding one of recesses formed in the surface (+Z-side surface) of the substrate 201 (see FIG. 3). Each conductor member is embedded in the substrate 201. However, the recesses (steps) for the conductor members need not be formed in the surface of the substrate 201. Each conductor member may be joined to a flat surface of the substrate 201. Each conductor member may be made of any material and may have any shape.

The wiring board 200 is electrically connected to the battery circuit unit 30. As shown in FIG. 2, the battery circuit unit 30 includes an overall positive terminal 31, an overall negative terminal 32, a J/B 33, a fuse 34, and electrical wires L1 to L4. The overall positive terminal 31 is located at the end on the cathode side of all the power storage stacks S1 to S6 (all the power storage cells). The overall negative terminal 32 is located at the end on the anode side of all the power storage stacks S1 to S6 (all the power storage cells). The electrical wire L1 electrically connects the conductor member 232 and the conductor member 233. The electrical wire L2 electrically connects the conductor member 234 and the conductor member 235. The fuse 34 is provided on the electrical wire L2. The conductor member 236 is connected to the overall positive terminal 31. The electrical wire L3 electrically connects the overall positive terminal 31 and the J/B 33. The conductor member 231 is connected to the overall negative terminal 32. The electrical wire L4 electrically connects the overall negative terminal 32 and the J/B 33. The J/B 33 houses various electrical devices. The J/B 33 may include at least one of a relay, a fuse, a resistive element, a current sensor, and a connector (e.g., a connector to an in-vehicle charger). The battery circuit unit 30 may further include either or both of a battery management system (BMS) and an electronic control unit (ECU).

The partition wall 104 may have openings for passing the conductor members 231 to 236 therethrough. Alternatively, an electrical wire (e.g., a cable) connected to the wiring board 200 may be passed above the partition wall 104 and connected to the battery circuit unit 30. The partition walls 103, 104 need not be provided. Either or both of the partition walls 103, 104 may be omitted.

The power storage stacks S1 to S6 each include the same number of power storage cells, and are disposed such that the positions of the power storage cells are aligned among the power storage stacks S1 to S6. Accordingly, each set of six power storage cells 10 arranged in the Y-direction forms a row (row in the Y-direction). The rows are arranged in the X-direction. A total of “6×N” power storage cells 10 are arranged in a matrix with six rows in the Y-direction and N columns in the X-direction. In the wiring pattern shown in FIG. 2, a plurality of parallel-connected units is connected in series. In each power storage stack, the N power storage cells 10 are disposed such that the positional relationship between the electrode terminal 11 (cathode terminal) and the electrode terminal 12 (anode terminal) is reversed every two power storage cells 10. Each of the conductor members 211 to 216 connects every two power storage cells of its corresponding power storage stack in parallel and connects the resulting parallel-connected units (the power storage cells connected in parallel) in series. How the power storage cells are connected can be changed as appropriate. For example, the number of power storage cells connected in parallel may be three or more, instead of two. All the power storage cells may be connected in series instead of forming the parallel-connected units.

The substrate 201 of the wiring board 200 has openings h2 shown in FIG. 3 at the same positions in an X-Y plane as the openings h1 (FIG. 1). The number of openings h2 is the same as the number of openings h1 (6×N), and each of the openings h2 faces the valve 13 of a corresponding one of the power storage cells 10 in the Z-direction. The openings h2 are holes that extend through the substrate 201. The openings h2 have a larger dimension in the X-Y plane than the openings h1 (FIG. 1). In the X-Y plane, each opening h1 is located inward of a corresponding opening h2. As shown in FIG. 3, each opening h2 is connected to a corresponding opening h1 via a corresponding lid 105a. The openings h2 are formed by, for example, punching.

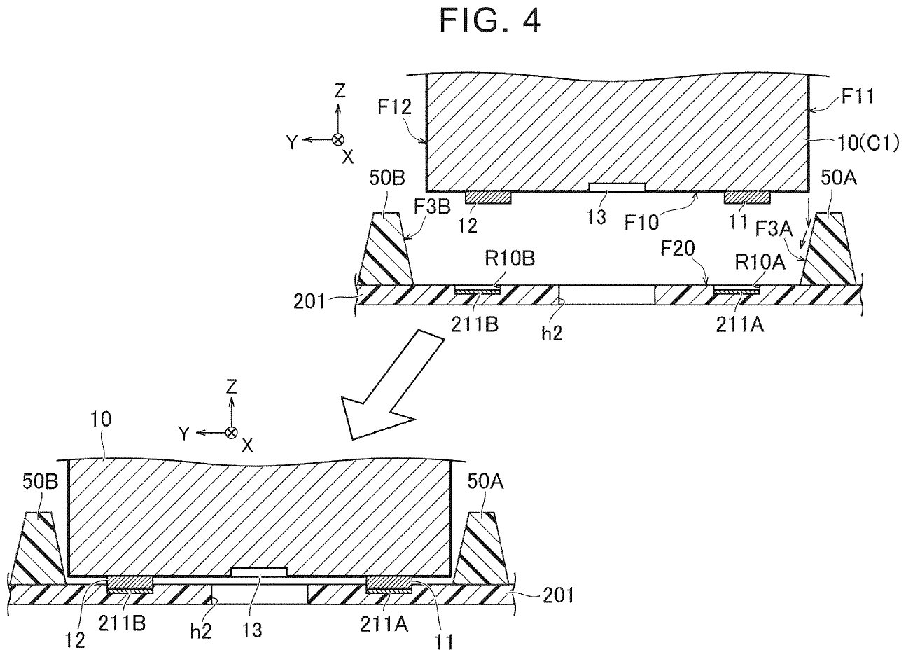

As shown in FIG. 2, two guide members 50 are provided on both sides (more specifically, on the +Y-side and the −Y-side) of each power storage cell to sandwich the corresponding power storage cell. In the manufacturing of the power storage device B, for example, after the wiring board 200 is installed in the lower case 100, the power storage stacks S1 to S6 are mounted on the wiring board 200 with the surfaces F10 of the power storage cells oriented downward in the vertical direction. At this time, the positions of the electrode terminals 11, 12 of the power storage cell 10 are adjusted by the two guide members 50 located on both sides of the power storage cell 10. The position adjustment by each guide member will be described in detail later (see FIG. 4). The electrode terminals of the power storage cells 10 and the conductor members of the wiring board 200 may be joined by clinching, thermocompression bonding, welding (e.g., laser welding), or an electrically conductive adhesive. The battery circuit unit 30 is connected to the wiring board 200, and the cooling device 20 is installed in the lower case 100. As a result, the interior of the lower case 100 is in the state shown in FIG. 2. The coolers 22C of the cooling device 20 may be installed in the lower case 100 together with the power storage stacks S1 to S6. Thereafter, the remaining parts of the cooling device 20 may be placed in the lower case 100, and each of the pipes 22A, 22B may be connected to the coolers 22C. Each of the wiring board 200 and the battery circuit unit 30 may be fixed to the lower case 100 by an adhesive.

The configuration of the guide members 50 and the position adjustment function of the guide members 50 will be described below with reference to FIGS. 3 and 4. Hereinafter, the power storage cell 10 located on the −Y-side out of the two power storage cells 10 shown in FIG. 3 will be referred to as “power storage cell C1,” and the power storage cell 10 located on the +Y-side out of the two power storage cells 10 shown in FIG. 3 will be referred to as “power storage cell C2.” The guide member 50 located on the −Y-side out of the two guide members 50 located on both side of the power storage cell C1 will be referred to as “guide member 50A,” and the guide member 50 located on the +Y-side out of the two guide members 50 located on both side of the power storage cell C1 will be referred to as “guide member 50B.” The conductor member 211 connected to the electrode terminal 11 of the power storage cell C1 out of the two conductor members 211 connected to the power storage cell C1 will be referred to as “conductor member 211A,” and the conductor member 211 connected to the electrode terminal 12 of the power storage cell C1 out of the two conductor members 211 connected to the power storage cell C1 will be referred to as “conductor member 211B.” The power storage cell C1 and the power storage cell C2 are examples of the “first power storage cell” and the “second power storage cell” according to the present disclosure, respectively.

As shown in FIG. 2, the power storage cell C1 belongs to the power storage stack S1, and the power storage cell C2 belongs to the power storage stack S2. As shown in FIG. 3, the guide member 50B is located between the power storage cell C1 and the power storage cell C2 in the Y-direction. The guide member 50A is located between the power storage cell C1 and the side wall W3 of the lower case 100 in the Y-direction. In the power storage cells 10 belonging to any of the power storage stacks S2 to S5, each of the two guide members 50 located on both sides of the corresponding power storage cell is disposed between the corresponding power storage cell and a power storage cell located adjacently (on the +Y-side or the −Y-side) as shown in FIG. 2.

As shown in FIG. 3, each of the power storage cells C1, C2 includes the electrode terminals 11, 12 and the valve 13 (exhaust valve) on the surface F10 oriented downward in the vertical direction. The upper cover 110 is joined to the upper surfaces (+Z-side surfaces) of the side walls W1 to W4 shown in FIGS. 1 and 2 (only the side wall W3 is shown in FIG. 3) via, for example, an adhesive 110b, and is further fastened by bolts 110a. The common panel 120 is joined to the lower surfaces (−Z-side surfaces) of the side walls W1 to W4 via, for example, an adhesive 120b. Although not shown in FIG. 3, the pipe 22A shown in FIG. 2 is disposed in a space V3 between the side wall W3 and the power storage cells 10 located at the −Y-side end in the lower case 100.

An exhaust passage P1 is formed between the bottom wall 101 of the lower case 100 and the common panel 120. The side walls W1 to W4 are hollow. As shown in FIG. 3, an exhaust passage P3 is formed inside the side wall W3. Although not shown in the figures, an exhaust passage is also formed inside each of the side walls W2, W4 in a manner similar to that of the exhaust passage P3 of the side wall W3. These exhaust passages communicate with each other. The side wall W2 has exhaust holes connected to the exhaust valves 151, 152 (FIG. 2). These exhaust holes communicate with the exhaust passage.

When the pressure inside the power storage cell 10 exceeds a first reference value, the valve 13 opens as shown in FIG. 3. As a result, a hole is formed in the lid 105a facing the valve 13 due to the pressure and heat of gas discharged from inside the power storage cell 10 through the valve 13. The gas discharged from the power storage cell 10 passes through the hole and flows into the exhaust passage P1. Each of the exhaust valves 151, 152 shown in FIG. 2 opens when the pressure in the exhaust passage exceeds a second reference value. The second reference value may be a pressure value lower than the first reference value. The exhaust valves 151, 152 are, for example, check valves. When either or both of the exhaust valves 151, 152 open, gas in each exhaust passage flows toward the open exhaust valve(s) and is exhausted to the outside of the power storage device B through that exhaust valve(s). The thickness of each lid 105a provided on the lower case 100 (FIG. 1) is set to a thickness small enough that a hole is formed when the valve 13 facing the lid 105a opens (e.g., when the valve opens in a manner that causes ignition).

A mica layer 120a (e.g., mica foil) is provided on the inner (+Z-side) surface of the common panel 120. The mica layer 120a may be provided to overlap all of the lids 105a in the X-Y plane. The mica layer 120a protects the common panel 120 from substances (gas, electrolyte solution, debris, etc.) discharged from the power storage cells 10 through the lids 105a.

The electrode terminals 11, 12 of the power storage cell C1 are electrically connected to the conductor members 211A, 211B, respectively. The electrode terminal 11 of the power storage cell C2 is electrically connected to the conductor member 212. The wiring board 200 includes the wiring pattern formed by the conductor members (e.g., busbars) including the conductor members 211A, 211B, 212 (see FIG. 2). Although not shown in FIG. 3, the electrode terminal 12 of the power storage cell C2 is also electrically connected to the wiring pattern of the wiring board 200. With the above configuration, electrical connection and exhaust of each of the power storage cells can be performed easily and appropriately. By aligning the electrode terminals of the power storage cells 10 with the conductor members of the wiring board 200, the positions of the valves 13 can be aligned with the positions of the openings h1 of the lower case 100. Each of the conductor members 211A, 211B shown in FIG. 3 is an example of the “first conductor member” according to the present disclosure. The conductor member 212 shown in FIG. 3 is an example of the “second conductor member” according to the present disclosure.

FIG. 4 illustrates the configuration and function of the guide members 50. Referring to FIG. 4, the distance between the conductor members 211A and 211B is set equal to the distance between the electrode terminals 11 and 12 of the power storage cell 10. Recesses R10A and R10B are formed in the substrate 201, and the conductor members 211A, 211B are provided in the recesses R10A, R10B of the substrate 201, respectively. The thickness of the conductor member 211A is smaller than the depth dimension of the recess R10A, and the entire conductor member 211A is located within the recess R10A. The thickness of the conductor member 211B is smaller than the depth dimension of the recess R10B, and the entire conductor member 211B is located within the recess R10B. The surfaces (+Z-side surfaces) of the conductor members 211A, 211B are located on the −Z-side of a surface F20 (principal surface on the +Z-side) of the substrate 201. With this structure, the conductor members 211A and 211B are less susceptible to damage. FIG. 4 shows the sectional structures of the two representative conductor members (conductor members 211A and 211B), but the other conductor members included in the wiring board 200 also have similar sectional structures.

Each of the guide members 50A, 50B is a projection that projects from the surface F20 of the substrate 201 toward the +Z-side. Each of the guide members 50A, 50B is configured to guide the power storage cell 10 such that the positions of the electrode terminals 11, 12 of the power storage cell 10 and the positions of the conductor members 211A, 211B are aligned, respectively, when the power storage cell 10 is mounted. Specifically, the guide member 50A is configured to guide a side surface F11 (first side surface) of the power storage cell 10 on the −Y-side. The guide member 50B is configured to guide a side surface F12 (second side surface) of the power storage cell 10 on the +Y-side. The guide member 50A includes a slope F3A (first slope) having an increasing distance from the side surface F11 toward the tip (+Z-side end) of the guide member 50A from the surface F20 of the substrate 201. The guide member 50B includes a slope F3B (second slope) having an increasing distance from the side surface F12 toward the tip (+Z-side end) of the guide member 50B from the surface F20 of the substrate 201. The guide members 50A, 50B are examples of the “first projection” and the “second projection” according to the present disclosure, respectively.

Each of the guide members 50A, 50B has, for example, a truncated cone shape. Each of the guide members 50A, 50B may be made of an insulating material. Each of the guide members 50A, 50B may contain a resin (e.g., a thermosetting resin). Each of the guide members 50A, 50B is, for example, formed separately from the substrate 201 and then joined to the substrate 201. However, the present disclosure is not limited to this, and the guide members 50A, 50B and the substrate 201 may be formed seamlessly and integrally.

As shown in FIG. 4, when the power storage cell 10 is mounted on the wiring board 200, the power storage cell 10 is moved closer to the wiring board 200 (−Z-side). When part of the power storage cell 10 (e.g., the surface F10) abuts against the slope F3A of the guide member 50A, the position of the power storage cell 10 is adjusted to the +Y-side by the slope F3A. The position of the power storage cell 10 is thus adjusted such that the positions of the electrode terminals 11, 12 of the power storage cell 10 are aligned with the positions of the conductor members 211A, 211B, respectively. When the power storage cell 10 abuts against the slope F3B of the guide member 50B, the position of the power storage cell 10 is adjusted to the −Y-side by the slope F3B. The position of the power storage cell 10 is thus adjusted such that the positions of the electrode terminals 11, 12 of the power storage cell 10 are aligned with the positions of the conductor members 211A, 211B, respectively. The base end of each of the guide members 50A, 50B may be in contact with the power storage cell 10 mounted on the wiring board 200. Each of the guide members 50A, 50B may serve as a bracket for the power storage cell 10. After the power storage cell 10 is connected to the wiring pattern of the wiring board 200, the power storage cell 10 may be fixed (e.g., fastened) to each of the guide members 50A, 50B. Each of the power storage stacks S1 to S6 may be mounted on the wiring board 200 in a bound state. Since the coolers 22C are disposed between the power storage cells 10 adjacent to each other in the X-direction as shown in FIG. 2, misalignment in the X-direction is unlikely to occur.

The guide member 50B disposed between the power storage cell C1 and the power storage cell C2 shown in FIG. 3 has a truncated cone shape. Therefore, the slope F3B of the guide member 50B exerts the position adjustment function not only for the power storage cell C1 but also for the power storage cell C2. The guide member 50B is configured to, when the power storage cells C1 and C2 are mounted, guide the power storage cell C1 such that the positions of the electrode terminals of the power storage cell C1 are aligned with the positions of the conductor members 211, and guide the power storage cell C2 such that the positions of the electrode terminals of the power storage cell C2 are aligned with the positions of the conductor members 212. By mounting the power storage cells C1 and C2 on the wiring board 200, the electrode terminals of the power storage cells are electrically connected to the wiring pattern of the wiring board 200 as shown in FIG. 3.

With the single guide member adjusting the positions of a plurality of power storage cells as described above, the number of guide members can be reduced, which is advantageous for the reduction in size and cost of the power storage device. With the insulating guide member 50B present between two adjacent power storage cells, the electrical insulation properties between the power storage cells are improved. The guide member 50B may also serve as a bracket for the power storage cells C1, C2. After the power storage cells C1 and C2 are connected to the wiring pattern of the wiring board 200, the power storage cells may be fixed to the guide member 50B.

The shape of each of the guide members 50A, 50B is not limited to the truncated cone shape, and can be changed as appropriate. For example, each of the guide members 50A, 50B may have a truncated pyramid shape (e.g., a truncated triangular, quadrangular, or pentagonal pyramid shape). The material of each of the guide members 50A, 50B is not limited to the insulating material, and may be any material. For example, each of the guide members 50A, 50B may be made of metal (e.g., stainless steel or aluminum).

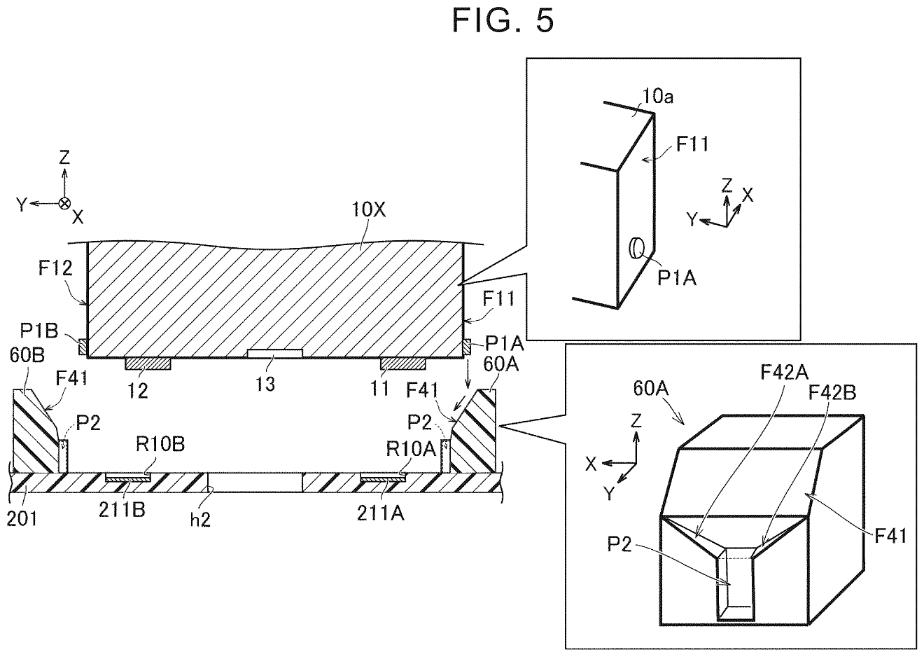

The configuration of the power storage cell and the guide members is not limited to the configuration shown in FIGS. 3 and 4, and can be modified as appropriate. FIG. 5 shows the configuration of a power storage cell and guide members according to a modification.

Referring to FIG. 5, in the present modification, a power storage cell 10X has the same configuration as the power storage cell 10 shown in FIG. 3, except that projections P1A and P1B are added to the side surfaces of the power storage cell 10X. Specifically, the side surface F11 of the case 10a of the power storage cell 10X on the −Y-side is provided with the projection P1A (third projection) that projects toward the −Y-side (toward a guide member 60A). The side surface F12 of the case 10a of the power storage cell 10X on the +Y-side is provided with the projection P1B (fourth projection) that projects toward the +Y-side (toward a guide member 60B). The shape of each of the projections P1A, P1B is, for example, a columnar shape. However, the present disclosure is not limited to this, and the shape of each of the projections P1A, P1B may be an elliptical column, rectangular column, truncated cone, or truncated pyramid shape.

As shown in the perspective view in the lower right of FIG. 5, the guide member 60A includes a slope F41 for position adjustment in the Y-direction, slopes F42A, F42B for position adjustment in the X-direction, and a housing portion P2 (e.g., a groove in the Z-direction). The slope F41 of the guide member 60A has an increasing distance from the side surface F11 toward the tip (+Z-side end) of the guide member 60A. The housing portion P2 (first housing portion) of the guide member 60A is configured to house the projection P1A. The slope F42A is higher toward the +X-side from the housing portion P2. The slope F42B is higher toward the −X-side from the housing portion P2.

The guide member 60B has a similar configuration to that of the guide member 60A. Each of the guide members 60A, 60B is disposed such that the housing portion P2 and the slope F41 are oriented toward the power storage cell 10X. The slope F41 of the guide member 60B has an increasing distance from the side surface F12 toward the tip of the guide member 60B. The housing portion P2 (second housing portion) of the guide member 60B is configured to house the projection P1B.

When the power storage cell 10X is moved closer to the wiring board 200 (−Z-side) to mount the power storage cell 10X and the projection P1A abuts against the slope F41 of the guide member 60A, the position of the power storage cell 10X is adjusted to the +Y-side by the slope F41. When the projection P1A abuts against the slope F42A of the guide member 60A, the position of the power storage cell 10X is adjusted to the −X-side by the slope F42A. When the projection P1A abuts against the slope F42B of the guide member 60A, the position of the power storage cell 10X is adjusted to the +X-side by the slope F42B. When the projection P1B abuts against the guide member 60B, the position of the power storage cell 10X is adjusted in a similar manner. In this manner, the guide members 60A, 60B shown in FIG. 5 can also adjust the position of the power storage cell 10X such that the positions of the electrode terminals 11, 12 of the power storage cell 10X are aligned with the positions of the conductor members 211A, 211B, respectively. When the power storage cell 10X is mounted on the wiring board 200, the projection P1A is housed in the housing portion P2 of the guide member 60A, and the projection P1B is housed in the housing portion P2 of the guide member 60B.

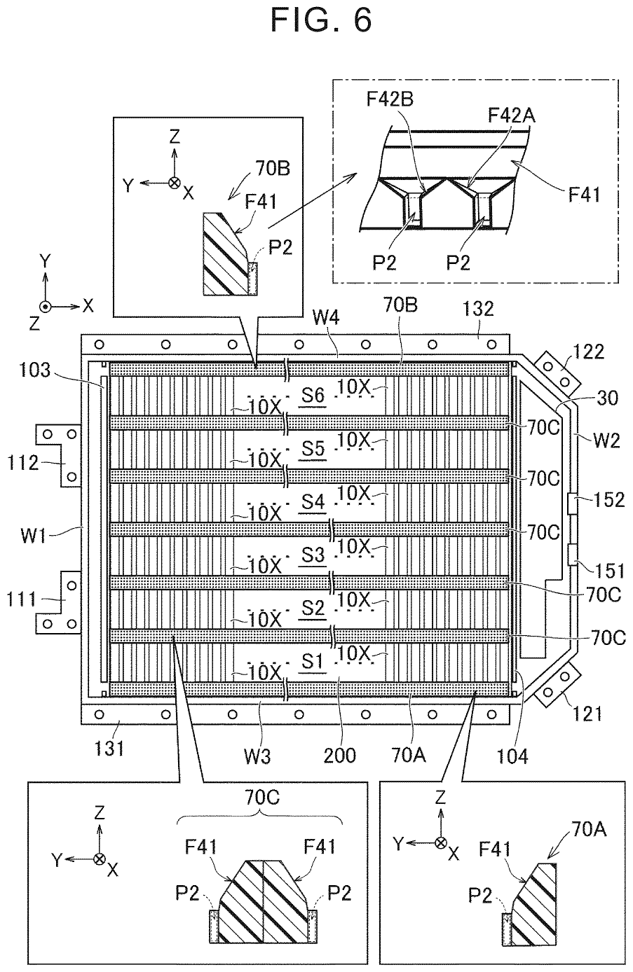

FIG. 6 shows a modification of the configuration shown in FIG. 2. In the present modification, the cooling device 20 (FIG. 2) is omitted, and each of the power storage stacks S1 to S6 includes N power storage cells 10X (see FIG. 5). A guide member 70A that is elongated in the X-direction is disposed between the power storage stack S1 and the side wall W3 of the lower case 100. The guide member 70A has the same sectional structure as, for example, the guide member 60A shown in FIG. 5. However, the guide member 70A includes N housing portions P2. A guide member 70B that is elongated in the X-direction is disposed between the power storage stack S6 and the side wall W4 of the lower case 100. The guide member 70B has the same sectional structure as, for example, the guide member 60B shown in FIG. 5. However, the guide member 70B includes N housing portions P2. Guide members 70C that are elongated in the X-direction are each disposed between adjacent power storage stacks. The guide member 70C has, for example, a sectional structure obtained by combining those of the guide members 60A and 60B shown in FIG. 5. That is, the guide member 70C includes, on each of the +Y-side and the −Y-side, the slope F41 extending in the X-direction, N housing portions P2, and the slopes F42A, F42B provided for each housing portion P2. In the modification shown in FIG. 6, each of the guide members 70A, 70B and the five guide members 70C has a dimension in the X-direction from one end to the other end of the power storage stack. Each guide member is formed over the entire power storage stack. With this configuration, the number of guide members can be reduced, thereby facilitating the manufacturing of the power storage device. The cooler for cooling the power storage stacks S1 to S6 (power storage cells) may be provided above the power storage stacks S1 to S6 (power storage cells). The cooler may be provided to cover the upper surfaces of all of the power storage cells.

The various features of the power storage device described above (the features described in the embodiment and the modifications) may be applied in any combination. The power storage device may be used for any purpose. The power storage device may be used in vehicles other than automobiles, mobile machines (such as agricultural machines and construction machines), unmanned moving objects, robots, or buildings.

The embodiment disclosed herein should be considered to be illustrative in all respects and not restrictive. The scope of the present disclosure is set forth in the claims rather than in the above description of the embodiment, and is intended to include all modifications within the meaning and scope equivalent to the claims.

What is claimed is:

1. A power storage device comprising a first power storage cell including an electrode terminal, and a wiring board, wherein:
the wiring board includes a substrate and a first conductor member provided on the substrate;
the electrode terminal of the first power storage cell and the first conductor member are electrically connected to each other; and
the substrate is further provided with one or more guide members that guide the first power storage cell such that a position of the electrode terminal is aligned with a position of the first conductor member.

2. The power storage device according to claim 1, wherein the one or more guide members include a first projection that projects from the substrate to guide a first side surface of the first power storage cell, and a second projection that projects from the substrate to guide a second side surface of the first power storage cell.

3. The power storage device according to claim 2, wherein:
the first projection includes a first slope having an increasing distance from the first side surface toward a tip of the first projection; and
the second projection includes a second slope having an increasing distance from the second side surface toward a tip of the second projection.

4. The power storage device according to claim 3, wherein:
the first side surface is provided with a third projection that projects toward the first projection;
the first projection includes a first housing portion that houses the third projection;
the second side surface is provided with a fourth projection that projects toward the second projection; and
the second projection includes a second housing portion that houses the fourth projection.

5. The power storage device according to claim 1, further comprising a second power storage cell including an electrode terminal, an upper cover, a lower case, and a common panel, wherein:
the first power storage cell, the second power storage cell, and the wiring board are housed between the lower case and the upper cover;
the wiring board further includes a second conductor member provided on the substrate;
the electrode terminal of the second power storage cell and the second conductor member are electrically connected to each other;
the wiring board includes a wiring pattern provided by a plurality of conductor members including the first conductor member and the second conductor member;
the one or more guide members include a guide member disposed between the first power storage cell and the second power storage cell to guide the first power storage cell such that the position of the electrode terminal of the first power storage cell is aligned with the position of the first conductor member, and to guide the second power storage cell such that a position of the electrode terminal of the second power storage cell is aligned with a position of the second conductor member;
each of the first power storage cell and the second power storage cell includes the electrode terminal and an exhaust valve on a surface oriented downward in a vertical direction; and
an exhaust passage is provided between the lower case and the common panel.
